(19) United States
(12) Patent Application Publication
(10) Pub. No.: US 2025/0042085 A1
(43) Pub. Date: Feb. 6, 2025

(54) ASSEMBLY AND METHOD FOR APPLYING PARTICULATE BUILDING MATERIAL IN A 3D PRINTER

(71) Applicant: Laempe Mössner Sinto GmbH, Barleben (DE)

(72) Inventors: Frank WEDEMEYER, Zell im Wiesental (DE); Rudolf WINTGENS, Schopfheim (DE); Andreas MÖSSNER, Salzburg (AT)

(21) Appl. No.: 18/846,916

(22) PCT Filed: Mar. 11, 2023
(86) PCT No.: PCT/DE2023/000016

§ 371 Date: Sep. 13, 2024

(30) Foreign Application Priority Data
Mar. 16, 2022 (DE) 10 2022 000 909.9

(51) Int. Cl. B29C 64/188; B22F 10/28; B22F 10/73; B22F 12/67; B28B 1/00; B29C 64/141; B29C 64/214; B29C 64/255; B29C 64/357; B33Y 10/00; B33Y 30/00

(52) U.S. Cl. CPC B29C 64/188; B22F 10/28; B22F 10/73; B22F 12/67; B28B 1/001; B29C 64/141; B29C 64/214; B29C 64/255; B29C 64/357; B33Y 10/00; B33Y 30/00

(57) ABSTRACT

An assembly and a method for applying particulate building material in a 3D printer, reduces forces acting on already applied layers of the particulate building material and partially already hardened regions of the particulate building material with the application of a further layer of the particulate building material. The assembly includes, in front of a smoothing means, when viewed in a moving direction of the smoothing means, a means for discharging excess particulate building material from an accumulation in front of the smoothing means. The method includes smoothing the particulate building material applied to a surface of the building field by an applicator, with said building material collecting in an accumulation in front of the smoothing means, by controlling the height of the accumulation such that particulate building material is partially removed from the accumulation.

The invention relates to an assembly for application of particulate build material in a 3D printer having a means of smoothing the particulate build material discharged by a discharger onto a build area.

The invention also relates to a method of applying particulate build material in a 3D printer, wherein particulate build material is applied layer by layer in a build area of the 3D printer.

It is known that individual or serial components, workpieces or shapes can be produced using what is called 3D printing or what is called a 3D printing method. In such printing methods, three-dimensional components or workpieces are produced in a layered construction.

They are constructed in a computer-controlled manner from one or more liquid or solid materials in defined dimensions and shapes. Requirements for the components or workpieces to be printed (3D structures) may be provided, for example, by what are called computer-aided design (CAD) systems in the form of 3D printing data.

In the printing of the 3D structures or 3D components, physical or chemical curing processes or a melting process take place in a particulate build material, also referred to as a molding material. Materials used for such 3D printing methods are build materials or molding materials such as plastics, synthetic resins, ceramics, unconsolidated sediments such as minerals or sands, and metals.

There are various known manufacturing procedures in the implementation of 3D printing methods.

However, a number of these procedures comprise the method steps described by way of example hereinafter:
application of particulate build material, also called particle material or pulverulent build material, over part or all of what is called a build area in order to form a layer of unconsolidated particle material, where the partial or full application of particulate build material comprises the discharge and the smoothing of the particulate build material;
selective consolidation of the layer of unconsolidated particulate build material applied in predetermined subregions, for example by selective compaction, printing or application of treatment agents, for example a binder, by means of a printhead or the use of a laser;
repetition of the preceding method steps in a further layer plane for layer-by-layer construction of the component or workpiece. The procedure envisaged for this purpose is to lower the component or workpiece that is constructed or printed layer by layer in the build area by one layer plane or layer thickness each time with the build area, or to lift the 3D print apparatus by one layer plane or layer thickness each time relative to the build area before a new layer is applied over part or all of the area;
subsequent removal of loose, unconsolidated particulate build material surrounding the component or workpiece manufactured.

Particulate build material is generally understood to mean an accumulation of individual particles of a substance or a substance mixture, where each particle has a three-dimensional extent. Since these particles can be regarded predominantly as round, oval or even elongated particles, it is possible to specify an average diameter for such a particle, which is usually in the range between 0.01 mm and 0.4 mm. Such a particulate build material may have fluid properties.

The prior art discloses various methods of creating a 3D structure or of discharging and applying particulate build material to a build area for creation of a 3D structure. DE 10117875 C1 discloses a method and an apparatus for application of fluids and the use thereof.

The method of applying fluids relates in particular to particle material which is applied to a region to be coated, with application of the fluid to the region to be coated in front of a blade, viewed in the direction of forward movement of the blade, followed by movement of the blade over the fluid applied.

The problem is that of providing an apparatus, a method and a use of the apparatus with which a very even distribution of fluid material in a region to be coated can be achieved.

For the solution, it is provided that the blade performs an oscillation in the manner of a rotary motion. The oscillating rotary motion of the blade fluidizes the fluid applied to the region to be coated. In this way, it is possible not only to apply particle material having a significant tendency to agglomerate in a very uniform and flat manner, but it is also possible to influence the compression of the fluid by the oscillation too.

In a preferred embodiment, it is provided that the fluid is applied in excess to the region to be coated. In this way, the constant movement of the blade, which oscillates in the manner of a rotary motion, homogenizes the excess fluid, viewed in the direction of forward movement of the blade, in front of the blade in a roll formed from fluid or particle material by the forward movement of the blade. In this way, any cavities between individual lumps of particles can be filled and larger lumps of particle material are broken up by the rolling movement.

JP 6 380 948 B2 is concerned with the provision of a powder material feed for a three-dimensional shaping system that produces three-dimensionally shaped products from powder material. The shaping system is capable of suppressing the occurrence of irregularities in a powder material layer and of shaping an exactly shaped product with a higher speed than before.

For this purpose, a powder material feed is disclosed, which has an outlet from which a powder material is discharged onto a shaping stage, and a smoothing element disposed beyond the outlet in the direction of movement of the powder material feed. The smoothing element creates a powder material layer on the shaping stage that has a predetermined thickness of the powder material discharged from the outlet onto the shaping stage. In order to remove any excess amount of powder material, a suction device having a suction nozzle for removal by suction of the excess amount of powder material is provided.

DE 10 2015 015 353 A1 discloses a method and an apparatus for production of three-dimensional components. The problem to be solved is to provide a method and an apparatus which examine or, in a preferred embodiment, even control a reliable process sequence. In order to solve this problem, it is envisaged that a measurement of an excess amount of particle material is conducted. It is also disclosed that the measurement is effected at the end and/or during a coater run, where the measurement is effected in a locally resolved manner and preferably over an entire coater width.

US 2004/0173946 A1 discloses a method of producing three-dimensional bodies from particles by layer-forming methods (powder-based generative rapid prototyping methods), wherein the layer buildup is monitored by means of an optical control device. The problem to be solved is that of providing a method that enables the quality control of the layers applied before or after the curing, and from which repair measures can be inferred. For this purpose, particularly suitable particles or binder liquids are to be indicated, and a suitable control device is to be specified. In order to solve this problem, it is envisaged that an optical image of the applied, smoothed and/or cured layer be recorded by means of the monitoring device. The image of the layer is processed such that defects in the plane of the layer, especially particle defects or particle layer defects, and build defects can be detected. Particle defects mean both a surplus and a deficiency of particles in the layer.

JP 2001-9 921 A relates to a stereolithography apparatus for production of a three-dimensional resin model by selective curing of a photocurable resin by irradiation with light. The problem to be solved is that of providing a stereolithography apparatus capable of producing a highly exact shape model. In order to solve the problem, a smoothing part having a support section, a storage and conveying section, and a scraper section is provided, where the smoothing part can be moved across a resin surface at a movement speed. By means of the scraper section, excess uncured resin is scraped off and subsequently transported through the storage and conveying section. This material can be sucked away by means of a suction apparatus.

US 2019/0193150 A1 describes a system and a corresponding method of additive manufacture of a three-dimensional object for improvement of the packing density of a powder bed used in the manufacturing process. The system and the corresponding method enable packing of the powder with relatively high density. Such a packing with relatively high density leads to better mechanical interdigitation of the particles, which leads to lower sintering temperatures and a lower deformation of the 3D object during sintering. One embodiment of the system comprises means of adjusting a volume of a powder metered onto a surface of the powder bed in order to create an adjusted dosed volume. Also disclosed are means of distributing the adjusted dosed volume in order to create a smooth volume for formation of a smooth powder layer with controlled packing density across the surface of the powder bed. The controlled packing density enables uniform shrinkage without warpage of the 3D object during sintering in order to qualitatively produce higher-quality 3D-printed objects.

The prior art discloses various means of applying or discharging the particulate build material in a 3D printer. Such a means, referred to hereinafter as discharger, is described hereinafter. It will be apparent that it is also possible to use other means having the same effect for discharge of the particulate build material without affecting the core of the present invention.

In order to apply a layer of the particulate build material, for example, the discharger described in DE 10 2018 003 336 A1 is moved horizontally across the build area. The discharger described here by way of example is what is known as a fluidizer, where the particulate build material exits through an outlet and is discharged onto the surface of the build area, in order to form a new layer of particulate build material there with a fixed layer thickness. In order to form a uniform layer of particulate build material having a fixed layer thickness, it is customary in the prior art also to use a means of smoothing the layer of particulate build material, for example a blade.

The discharger has a funnel-shaped reservoir vessel for storage of the particulate build material, and an opening or an outlet disposed in the lower region of the discharger for discharge of the particulate build material. In addition, there are outlet means disposed in the lower region of the funnel-shaped reservoir vessel that prevent particulate build material from being discharged from the applicator onto the build area in an unwanted manner.

Application of a new layer of the particulate build material to the build area is achieved in that the particulate build material is released in the region of the discharge means.

Simultaneously with the release of the outlet means, the discharger is moved across the build area, and a new layer of the particulate build material is applied to the build area.

As already mentioned, the particulate build material applied in this way is smoothed, or smoothed and consolidated, by a means of smoothing the layer of the particulate build material applied, for example with a blade, with formation of an accumulation of the excessively discharged particulate build material in front of said means. The height and the shape of said accumulation are determined by the amount of the particulate build material excessively discharged by the discharger.

Since, in a case in which no excessive particulate build material is applied to the surface of the build area, faults can arise in which the particulate build material is not formed with a desired layer thickness in the layer to be currently applied, more or too much particulate build material is discharged for reasons of safety from a discharge onto the surface of the build area.

If a means of smoothing the layer of the particulate build material applied, for example a blade, is moved horizontally across a build area, the blade and the accumulation of the excessively discharged particulate build material that forms in front of said blade give rise to forces that act on the substrate. This substrate consists, for example, of several layers of the already discharged particulate build material, which has already consolidated selectively in subregions that are to form the 3D structure to be created. The size or the magnitude and the direction of these forces acting on the substrate is different locally. The magnitude of these forces is dependent, for example, on the inclination of the blade, on the height of the accumulation, which may be different at different points in the accumulation, on the speed of movement of the blade across the build area, and on the grain size and distribution of the particulate build material. Thus, forces of different strength act on the substrate at different sites, preferably beneath the accumulation.

Such forces generally have a horizontal component and a vertical component. The horizontal component, referred to as force FH, acts parallel to the surface of the build area in a region of the last applied layer of the particulate build material. The force FH is caused by the horizontal movement of the means of smoothing, such as a blade. The vertical component, referred to as force Fv, acts vertically to the surface of the build area or vertically to the last applied layer of the particulate build material. The force Fv is caused by the weight of the particulate build material, especially the particulate build material in the accumulation. In practice, the forces FH and Fv are superposed, giving rise to a resultant force FR. This resultant force FR is aligned at an angle to the surface of the build area or the perpendicular which is determined by the components of the forces FH and Fv and may be different at different sites in the accumulation, especially along the longitudinal extent of the accumulation. The magnitude of the resulting force FR may likewise be different in size at different sites.

These resultant forces FR that act on the substrate at an angle to the surface of the particulate build material applied lead, for example, to displacements in the layers of the particulate build material already applied, which may also have undergone partial selective consolidation. This results in inaccuracies with regard to the dimensions of the 3D structure to be created. If such inaccuracies exceed a certain tolerance, it is no longer possible in some cases to use the 3D structure created. Such a tolerance in the manufacture of a 3D structure may, for example, be in the region of less than ±0.5 mm, especially ±0.3 mm.

This means that, if an inaccuracy at just one point in the 3D structure to be created is greater than ±0.5 mm, especially greater than ±0.3 mm, the 3D structure created can no longer be used.

A further problem may be excessively high friction forces between the particles of the particulate build material itself or between the particles of the particulate build material and a blade of a means of smoothing, since this can result in impermissible point heating which affects, for example, the physical properties of the particulate build material.

Therefore, there are solutions known from the prior art that attempt to influence the size or amount of the accumulation in front of a means of smoothing, such as a blade, or to keep it constant in a defined size or amount. It may be the case here to determine the size of the accumulation, for example by means of a camera and a suitable algorithm, and, depending on the size of the accumulation ascertained, to influence an amount of the particulate build material discharged from a discharger onto the surface of the build area in order to keep the size of the accumulation constant, for example. It may also be the case here to keep the size of the accumulation in front of a means of smoothing to a minimum in order to minimize the forces acting on the substrate. This minimum or this minimum necessary height Hₘᵢₙ of the accumulation is required to be able to apply a layer of the particulate build material uniformly, with a fixed layer thickness and without defects.

A disadvantage of such solutions is that these solutions are complex and incur high costs and an elevated level of open-loop and closed-loop control complexity with regard to the discharge of the particulate build material. Moreover, such solutions cannot prevent different sizes of the accumulation along the longitudinal extent of the blade, which occur very often in practice. Thus, along the longitudinal extent of the blade, in spite of controlled influencing of the size of the accumulation, forces of different strength acting on the substrate occur. The effect of this is that stress of locally different intensity occurs in the selectively consolidated structures beneath along the length of the blade.

A further disadvantage of the known prior art in application of particulate build material in a 3D printer is that the accumulation of the particulate build material, after traveling across the build area, is usually no longer available in the current manufacturing process in the creation of the 3D structure. Particulate build material still in the accumulation after traveling across the build area may be collected, for example, in a collecting vessel. Several process steps are typically necessary in order to feed this applied particulate build material back to the manufacturing process.

There is thus a need for an improvement in the known prior art and hence for an improved assembly and an improved method for application of particulate build material in a 3D printer.

It is the object of the invention to specify an assembly and a method for application of particulate build material in a 3D printer, by means of which the forces acting on already applied layers of the particulate build material and partly already consolidated regions of the particulate build material are reduced on application of a further layer of the particulate build material.

Moreover, the quality of the layer to be currently applied and hence the accuracy of the dimensions of the 3D structures created are to be improved.

Moreover, it is to be made possible for at least some of the particulate build material in the accumulation which is not required for formation of the minimum necessary height Hₘᵢₙ of the accumulation to be returned directly to a reservoir vessel of a discharger.

Particulate build material not required for formation of the minimum necessary height Hₘᵢₙ of the accumulation is referred to hereinafter as excess particle material.

It is a general feature of the method that, in a step of smoothing the particulate build material that has been discharged by a discharger onto the surface of the build area and accumulates in the accumulation in front of the means of smoothing, this particulate build material is at least partly removed or taken away from the accumulation and returned to a reservoir vessel of the discharger. For this purpose, a correspondingly suitable means of removing or taking away the particulate build material from the accumulation is provided.

In this context, the process is controlled in such a way that only excess particulate build material not required for formation of a minimum necessary height Hₘᵢₙ of the accumulation is removed or taken away from the accumulation and returned to the reservoir vessel of the discharger. In this context, the minimum necessary height Hₘᵢₙ of the accumulation is that height H of the accumulation which is required to be able to apply a layer of the particulate build material uniformly, with a fixed layer thickness and without defects.

It is envisaged that the amount of the excess particulate build material removed from the accumulation, for example by suction, is controlled as a function of the amount of the particulate build material discharged by the discharger.

The amount of the excess particulate build material, i.e. the proportion of the particulate build material which is not required for proper formation of a new layer of particulate build material, depends on the amount of the particulate build material discharged from the discharger onto the surface of the build area. It is thus possible to control the excess particulate build material removed or taken away from the accumulation as a function of the amount of the particulate build material discharged.

It is alternatively the case that the amount of the excess particulate build material removed or taken away from the accumulation is controlled as a function of the height H of the accumulation.

A means of removing or taking away the particulate build material from the accumulation may be implemented in different ways. For example, it is possible to provide suitable suction means, brushes, squeegees, blades, paddles or troughs that partly remove or take away particulate build material from the accumulation. In addition, for transport of the particulate build material removed or taken away from the accumulation into a reservoir vessel of the discharger, it is possible to use mechanical conveyor systems such as a belt conveyor system, a bucket conveyor system, a screw system, a spiral conveyor system or an oscillating conveyor system. Alternatively, for transport of the particulate build material removed or taken away from the accumulation into a reservoir vessel of the discharger, it is possible to use pneumatic conveying systems such as a pressure conveyor, a suction conveyor, a suction-pressure conveyor or a plug flow or dense flow conveyor. The invention is described hereinafter using the example of a suction means that takes away particulate build material from the accumulation, which does not constitute a restriction of the invention to this execution of the means of removing or taking away the particulate build material from the accumulation.

The height H and the shape of the accumulation are determined by the amount of the excessive particulate build material applied by the discharger to the surface of the build area. The height H may, for example, be detected by optical means, and closed-loop control of the suction removal can have the effect of achieving a defined height H of the accumulation that corresponds to a minimum necessary height Hₘᵢₙ of the accumulation necessary to be able to apply a layer of the particulate build material uniformly, with a fixed layer thickness and without defects.

It is additionally the case that the amount of the excess particulate build material removed, or removed by suction, from the accumulation is controlled depending on one or more layers that may have what are called critical regions and are situated beneath the layer created in the smoothing step.

Regions in which there is the risk that application and smoothing of the particulate build material in the current layer leads to defects in the construction of the 3D structure in a layer beneath are referred to as critical regions. In this context, such defects are considered in particular to mean tearing and/or movement of regions or subregions of the 3D structure to be created.

Critical regions of this kind are also regions in which a substructure of the 3D structure to be created is to be applied to small substructures of a layer beneath. Such small substructures are formed, for example, when dimensions of the substructures disposed one on top of another in layers are sufficiently small that, in the case of a stacked structure of these substructures, for example, only low mechanical strengths are to be expected. Such low strengths are possessed by substructures having the smallest possible dimensions, for example in the region of a length of 0.1 mm and a width of 0.1 mm, up to dimensions in the region of a length of 5 mm or more and a width of 5 mm or more. These dimensions are dependent on the molding material, the processing speed of the molding material and the fluid properties. In addition, such critical regions may also comprise part of a current layer or be a complete layer, for example as a result of the demanding or complicated 3D structure to be manufactured or a weakly adhering substrate beneath the current layer, such as the surface of the build area.

Such critical regions are known via an analysis of the print data for creation of the 3D structure and can be considered in the creation of the 3D structure. The amount of the excess particulate build material removed, or removed by suction, from the accumulation depending on the critical regions is controlled in such a way that, on attainment of a critical region, the amount of the excess particulate build material removed from the accumulation is increased, with reduction in the height H of the accumulation. This removal of excess particulate build material is effected with observance of a minimum necessary height Hₘᵢₙ of the accumulation, which is not undershot.

On departure from the critical region, the amount of the excess particulate build material removed from the accumulation is reduced again, for example to a height H of the accumulation as prior to the attainment of the critical region.

This change in the height H of the accumulation in the critical regions may be coupled in time with a reduction in the speed of the tools of the 3D printer in these critical regions. Thus, for example, an applicator and/or a means of smoothing is moved with a reduced speed across the surface of the build area and, at the same time, the height H of the accumulation is reduced to a minimum.

This reduction in the height H of the accumulation with observance of the minimum necessary height Hₘᵢₙ of the accumulation can already be effected shortly before attainment of the critical region. For this purpose, a corresponding lead time or distance, for example between the applicator and the critical region, is fixed.

An increase in the height H of the accumulation when leaving the end of the critical region can be effected in a delayed manner by means of a delay time or a fixed distance between the critical region and the applicator.

This general method can be executed with various arrangements.

It is the case that excess particle material in the accumulation in front of the blade is taken up, for example, by suction and returned to a reservoir vessel of a discharger. By means of the particulate build material applied excessively to the surface of the build area by means of the discharger, an accumulation consisting of particulate build material required for formation of the minimum necessary height Hₘᵢₙ of the accumulation and excess particulate build material is formed in front of a means of smoothing, for example a blade. The excess particle material not required for proper formation of a new layer of particulate build material is sucked out of this accumulation. What remains is an accumulation having a significantly reduced volume or an accumulation having a significantly reduced height H.

What is envisaged in accordance with the invention is that the excess particulate build material in the accumulation in front of the means of smoothing, such as a blade, is taken up by suction, where the means of smoothing the particulate build material has a gap-shaped opening in the longitudinal extent of the blade, by means of which the excess particle material is removed by suction from the accumulation and returned to the reservoir vessel of the discharger. For this purpose, the blade is of partly hollow design, where the blade has a gap-shaped opening for removal of the excess particulate build material by suction and one or more openings for onward conduction of the particulate build material to a reservoir vessel for the particulate build material. For this purpose, the one or more openings are connected to a controllable means of generating a reduced pressure, which may be disposed in the means of smoothing. By virtue of the reduced pressure generated along the gap-shaped opening provided in the longitudinal extent of the blade, which is aligned in the direction of the accumulation, the excess particulate build material is sucked out of the accumulation.

If, for example, a lower edge of the gap-shaped opening in the blade is positioned at a particular distance A above the surface of the build area and the reduced pressure generated is controlled appropriately, it is possible to reduce the height H of the accumulation such that the height H of the accumulation corresponds to the distance A above the surface of the build area.

It is additionally the case that the blade is in two-part form, consisting of a main blade body and a blade plate, where the gap-shaped opening facing the accumulation is formed between the main blade body and the blade plate. The size of the gap or the gap size can be fixed by appropriate positioning of the blade plate relative to the main blade body.

A cavity is formed between the main blade body and the blade plate, which has the gap on the inlet side and which is connected to a suction outlet on the outlet side.

The expression “on the inlet side” is used here for an inlet through which the excess particulate build material moves from the accumulation into the hollow means of smoothing. The expression “on the outlet side” is used for an outlet through which the excess particulate build material is transported from the means of smoothing, for example, via a suction outlet and a corresponding connection to the reservoir vessel of the discharger.

It is alternatively the case that the blade plate is in a variable arrangement in respect of its distance from the main blade body that forms the gap. Such a change in the distance can be effected, for example, in an adjustment of the blade prior to operation in the 3D printer, with appropriate mechanical securing of the blade plate.

In a further execution, the securing of the blade plate is envisaged such that it can be moved or shifted by suitable means for the movement of the blade plate, with the distance varying from the main blade body. This movement or change in the gap size can also be effected in continuous operation of the 3D printer by the means for the movement of the blade plate.

In this way, available parameters for influencing the amount of the particulate material to be removed from the accumulation by suction are the size of the reduced pressure generated or a suction power and the size of the gap in the blade.

It is additionally the case that such a hollow blade consisting of a main blade body and an adjustable blade plate, for example, has a blade pocket which is disposed in the main blade body and which constitutes a region within the blade that is formed beneath a lower edge of the gap formed in the blade and within the blade. In the case of removal of the particulate build material by suction through the gap and a nearly vertical region of the blade of partly hollow form to a reservoir vessel, it is possible that a small number of particles of the particulate build material in the vertical region are not sucked in further or fall downward as a result of the gravity acting thereon. In order to prevent these particles from getting back onto the build area by virtue of their falling movement, the region within the blade is of approximately L-shaped form and has a blade pocket which is beneath the lower edge of the gap formed at its lowest point and in which the particles falling back accumulate.

It is further alternatively the case that the excess particulate build material in the accumulation in front of the blade is taken up by a gap-shaped opening in the longitudinal extent of the blade, where the blade has a main blade body and a blade plate and where a blade tip is disposed on the main blade body.

For this purpose, the blade is of partly hollow form, where the blade has a gap-shaped opening, disposed above the blade tip, for removal of the excess particulate build material by suction and one or more outlet-side openings for onward conduction of the particulate build material to a reservoir vessel for the particulate build material.

The blade tip is disposed in the lower region of the main blade body and is positioned with its lowest point or with its lower edge above the build area such that, in the case of the movement of the blade with its blade tip above the build area, a new layer of the particulate build material applied with a defined and desired layer thickness is formed beneath the blade. The excess particulate build material is conveyed over the top side of the blade to the longitudinal opening with the adjustable gap size in the direction of particle movement via the suction outlet and the connection to a reservoir vessel of the discharger.

A particular advantage of this execution is that the blade tip that is subject to wear over the course of operation of the 3D printer can be exchanged separately. Without this blade tip in front of the main blade body, the main blade body shows signs of wear, and then has to be exchanged alone or together with the blade plate.

The blade tip of wedge-shaped form, at its thinnest point, which protrudes the furthest from the main blade body to which it is secured, has a thickness of between 0.01 mm and 1.5 mm, preferably between 0.07 mm and 0.3 mm.

In order to prevent the particulate build material present in the accumulation in front of the means of smoothing, such as a blade, from leaving the edge of the build area and hence being lost, the means of smoothing has a guide profile at each of the two sides or ends. By means of these guide profiles, the accumulation is laterally bounded and prevents the accumulation in the edge regions from having a lower height H, since, in these edge regions, the particulate build material can fall or trickle off the build area. In this way, moreover, the losses of particulate build material when the means of smoothing travels across the build area are minimized, since the guide profiles prevent the particulate build material present in the accumulation from leaving the build area to the sides and no longer being available for the 3D printing process.

The guide profile may be disposed on and may be mechanically bonded to the blade plate. The guide profile has, for example, a triangular lateral boundary by which the guide profile protrudes from the blade plate and which forms a lateral boundary for the accumulation that forms in operation of the 3D printer. The guide profile may also have a triangular base plate aligned parallel to the surface of the build area, which forms a gradual transition between the guide profile and the means, especially the blade plate.

It is provided, for example to monitor the height H of the accumulation and to form, by virtue of closed-loop control of the reduced pressure to be generated, an accumulation in front of the blade, which has only the minimum necessary height Hₘᵢₙ. This means that excess particulate build material not necessary for formation of the minimum height Hₘᵢₙ of the accumulation is removed or sucked out of the accumulation. This decrease in the height H of the accumulation to the necessary minimum results in a reduction in the forces FH, Fv, FR that act on the substrate, especially on the critical regions.

There is thus a reduction in movements that occur in the layers of the already applied particulate build material, which may also have been partly selectively consolidated. As a result, there is a reduction in the inaccuracies with regard to the dimensions of the 3D structure to be created. The quality of the 3D structures created is improved since the accuracy in the manufacture of a 3D structure is increased.

The height H of the accumulation, depending on the speed of movement of the means of smoothing, such as a blade, across the build area and the amount of the particulate build material applied, may be for example more than 10 mm. The reduction according to the invention in the height H of the accumulation can reduce this height H to a significantly smaller value which is 8 mm, preferably 5 mm, further preferably 2 mm.

Depending on the blade geometry and intensity of the removal of the particulate build material, for example via removal by suction, the accumulation can also be avoided almost entirely, such that it has only a height H corresponding to the average particle size of the particulate build material of, for example, 0.5 mm, preferably 0.3 mm, further preferably 0.15 mm.

It is additionally the case that the excess particulate build material sucked out of the accumulation is returned to a reservoir vessel of a discharger. This direct recycling of the particulate build material into the reservoir vessel of the discharger reduces the amount of the particulate build material to be kept ready. For this direct recycling, it is possible to use the mechanical or pneumatic conveying systems already detailed further above. A further advantage of this direct recycling is that the particulate build material does not, as necessary in the prior art, first have to be sent to a complex purification or reprocessing of the particulate build material.

It is provided for controlling the height H of the accumulation to influence the means of generating the reduced pressure and, in that way, suck more or less excess particulate build material out of the accumulation.

The features and advantages of this invention that are elucidated above will be better comprehended and assessed after careful study of the detailed description below of the nonlimiting example configurations, preferred here, of the invention, together with the accompanying drawings, which show:

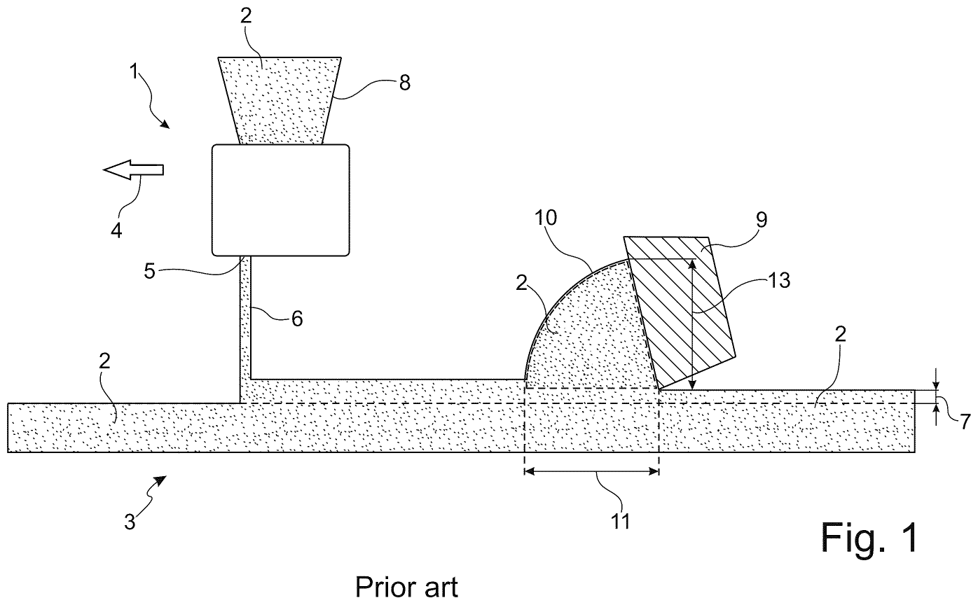

FIG. 1: an illustrative assembly for discharge of the particulate build material in a 3D printer according to the prior art,

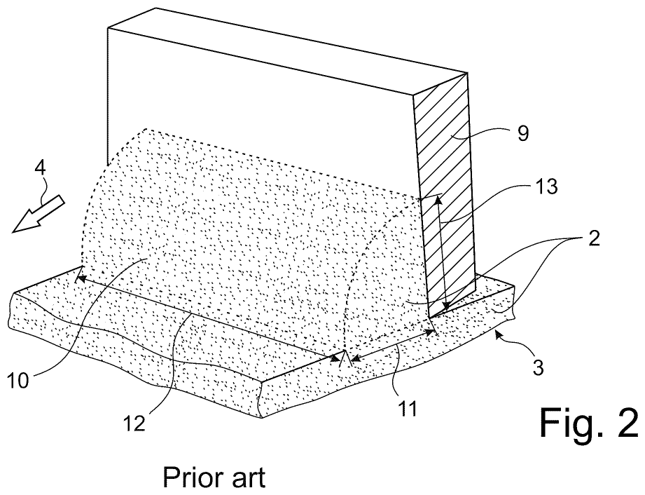

FIG. 2: a perspective diagram of an accumulation of the particulate build material in a build area,

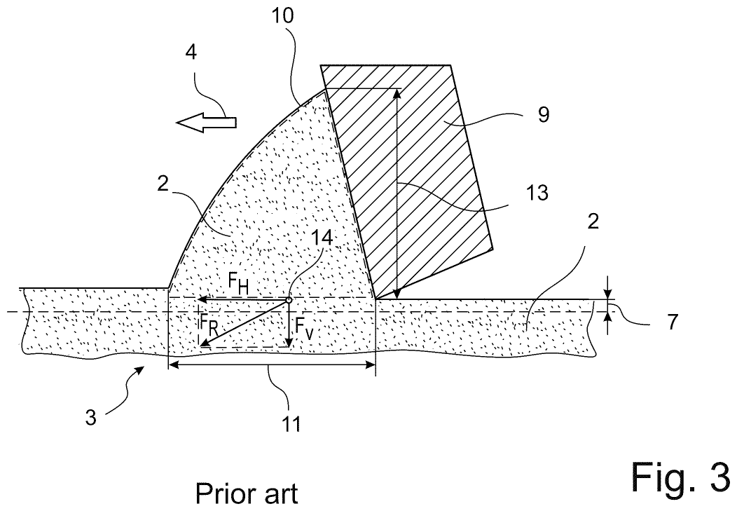

FIG. 3: an illustrative distribution of forces that act on the substrate in the event of a movement of a means, such as a blade, across a build area,

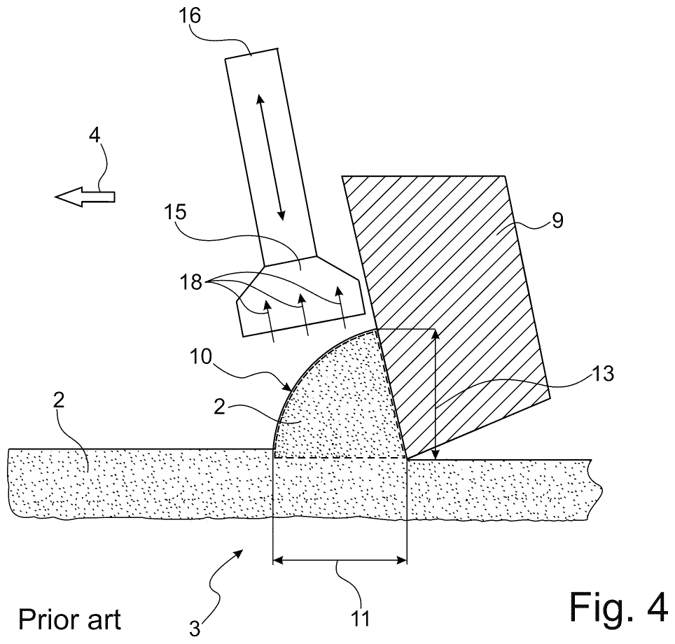

FIG. 4: an assembly having a means of removing or taking away the particulate build material from the accumulation according to the prior art,

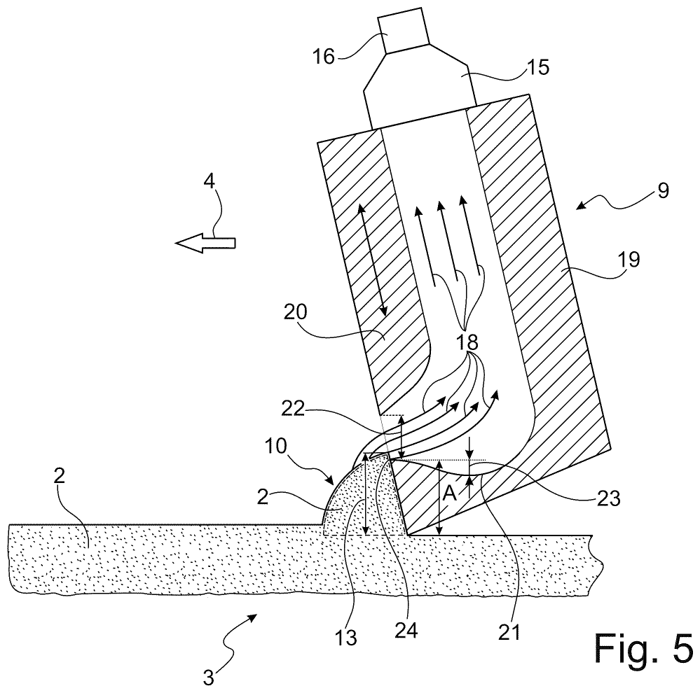

FIG. 5: a first assembly according to the invention with a suction outlet for suction of particulate build material out of the accumulation,

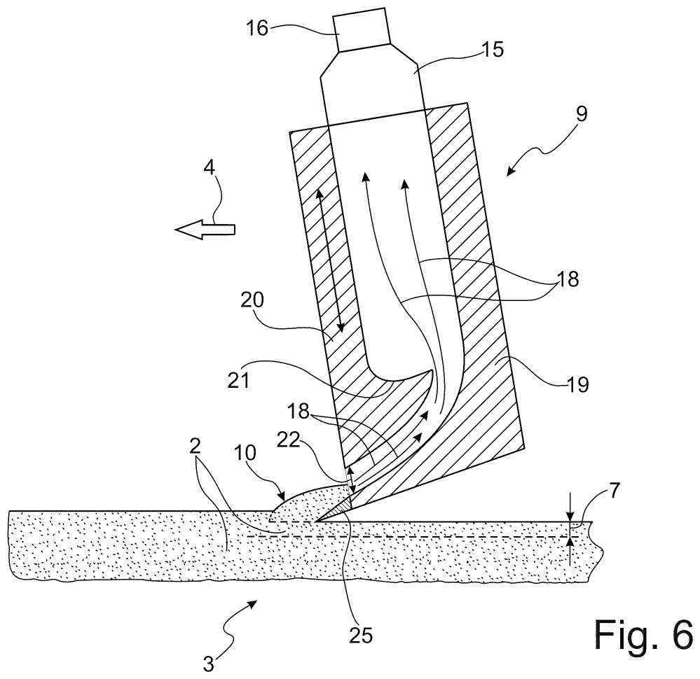

FIG. 6: a further assembly according to the invention with a suction outlet for suction of excess particulate build material out of the accumulation,

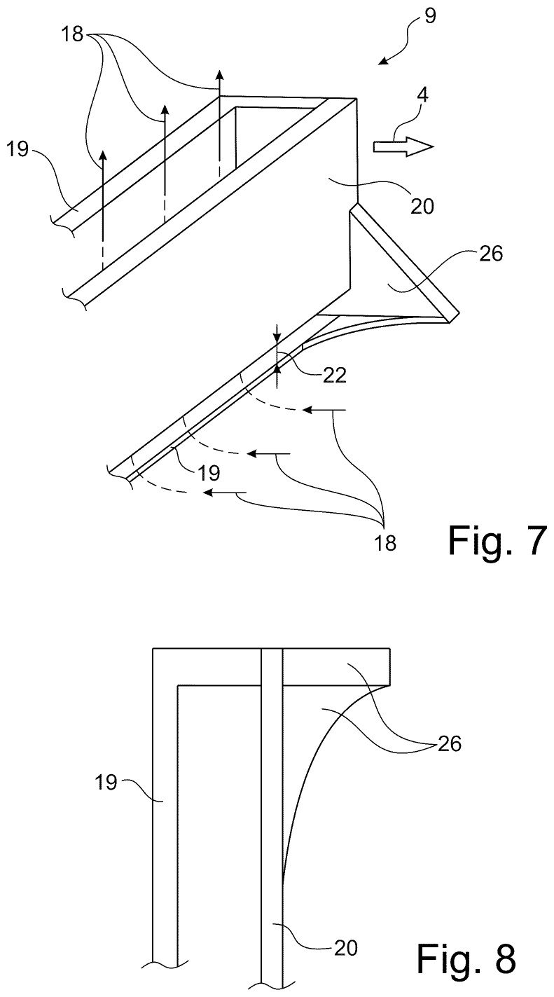

FIG. 7: a means according to the invention in a perspective view,

FIG. 8: the means according to the invention from FIG. 7 in a top view and

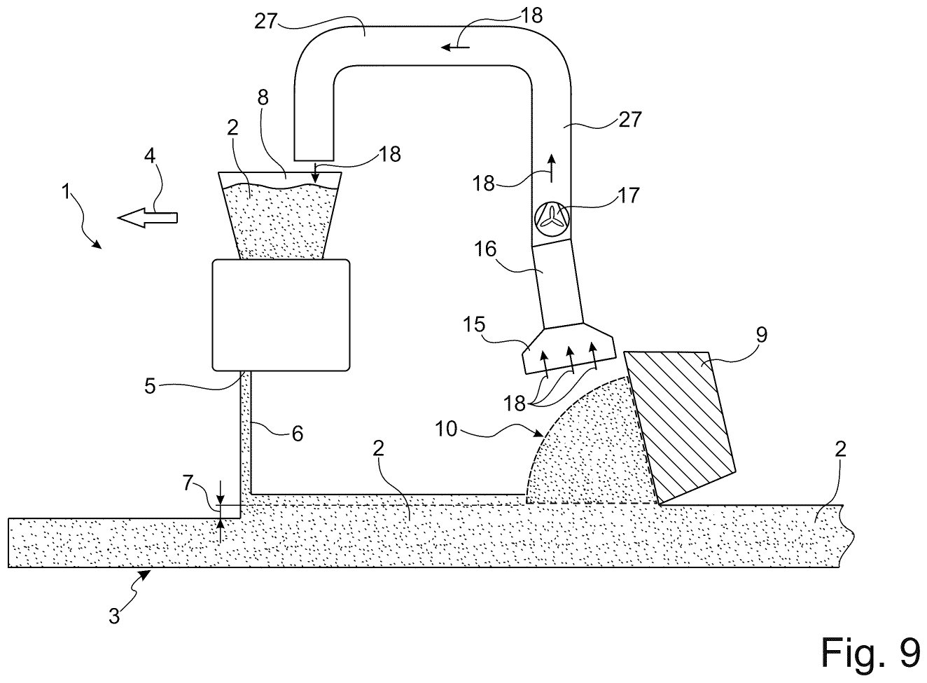

FIG. 9: recycling of the excess particulate build material from an accumulation into the reservoir vessel, illustrated using the example of the prior art.

FIG. 1 shows an illustrative assembly 1 for discharge of the particulate build material 2 in a 3D printer according to the prior art. Such an assembly 1 is also referred to as discharger 1. This assembly 1 for discharge of the particulate build material 2 is illustrative and can be replaced by other means having the same effect, without affecting the core of the present invention.

It is the case that the discharger 1 can be moved horizontally over a build area 3 in the direction of movement shown by the arrow 4.

The carrier 1 is shown in a snapshot in which particulate build material 2 exits from a reservoir vessel 8 via an outlet 5 and passes as discharge 6 to the surface of the build area 3 in order to form a new layer of particulate build material 2 there with a fixed layer thickness 7. A means 9 of smoothing the layer of particulate build material 2, for example a blade, is also used customarily according to the prior art to form this layer of particulate build material 2 with a fixed layer thickness 7.

For storage of the particulate build material 2, the discharger 1 has a funnel-shaped reservoir vessel 8. This funnel-shaped reservoir vessel 8 is of longitudinally extended form across the width of the build area 3, where the length thereof is several times the width thereof.

The reservoir vessel 8 has an opening or an outlet 5. Disposed at the outlet 5 is an outlet means, not shown in FIG. 1, which prevents particulate build material 2 from getting onto the build area 3 in an unwanted manner.

An application of the particulate build material 2 to the build area 3 is achieved in that the outlet means is actuated such that the particulate build material 2 is released in the region of the outlet 5, as a result of which the particulate build material 2 is discharged via the outlet 5, forming the discharge 6, and arrives in the build area 3. At the same time, the discharger 1, in the direction of movement illustrated by the arrow 4, is moved across the build area 3, and a new layer of the particulate build material 2 is applied in the build area 2. As already mentioned, the particulate build material 2 applied in this way is smoothed, or smoothed and consolidated, by a means 9 of smoothing the layer of the particulate build material 2 applied, for example with a blade. For this purpose, the means 9 of smoothing is also moved across the build area 3 in the direction of movement illustrated by the arrow 4, where the speed of movement of the discharger 1 and of the means 9 of smoothing across the build area 3 may be the same.

In order to control the amount of the particulate build material 2 to be discharged, the outlet means is actuated correspondingly, wherein as a result, for example, more fluidized particulate build material 2 can exit through the outlet 5, and the size or amount of an accumulation 10 of particulate build material 2 that forms in front of the means 9 of smoothing increases.

Alternatively, the outlet means may be actuated such that the same amount of or less particulate build material 2 is discharged. This achieves the effect that the size or amount of the accumulation 10 of particulate build material 2 that forms in front of the means 9 of smoothing remains the same or decreases.

If particular demands are placed on the accuracy of the 3D structure to be created, where variances in the production of a 3D structure are to be less than ±0.5 mm, especially less than ±0.3 mm, such control of the applied layer of the particulate build material 2 is inadequate.

FIG. 1 shows a diagram of a side view of an accumulation 10 of the particulate build material 2 in a build area 3 in a 3D printer from the prior art. The means 9 of smoothing the particulate build material 2 discharged is shown by way of example as a blade, and is moved across the build area 3 in the direction of movement shown by the arrow 4.

An accumulation 10 of the particulate build material 2 forms in front of the means 9 of smoothing the discharged particulate build material 2. The region encompassed by the accumulation 10 is shown in encircled form by a dash-dash line for better understanding in FIG. 1.

If the means 9 of smoothing the discharged particulate build material 2 is moved across the build area 3, a new layer of the particulate build material 2 having the given layer thickness 7 is applied.

The accumulation 10 shown in FIG. 1 has a depth T 11, a width B 12 and a height H 13. The width B 12, not shown in FIG. 1, of the accumulation 10 effectively extends depthwise in the representation of FIG. 1.

For example, if the height H 13 of the accumulation 10 exceeds a maximum necessary value, there can be a deterioration in the quality of the layer to be currently applied and hence an effect on the accuracy of the 3D structure to be created.

The reason for this may be an increasing force on underlying layers of the particulate build material 2. An impermissibly high force leads, for example, to the nonuniform collapsing or compaction of individual regions in a layer or in multiple layers of the particulate build material 2 applied. Alternatively, the impermissibly high force may affect the density of subregions of one or more underlying layers. As well as an effect on the particulate build material 2, there may also be an effect on already consolidated regions that are to form the 3D structure. Such an effect leads, for example, via compression or movement of such an already consolidated region, to variances in the dimensional accuracy of the 3D structure to be created.

For avoidance of such effects on the 3D structure to be created and for assurance of a uniform quality in the application of the particulate build material 2, the present method keeps the amount or the volume or the height H 13 of the accumulation 10 constant, for example via the length of the means 9 of smoothing or the width B 12 of the accumulation 10, or controls it to a defined value.

FIG. 2 shows a perspective view of an accumulation 10 of the particulate build material 2 in a build area 3 in a 3D printer according to the prior art.

For better illustration, FIG. 2 shows a detail of the accumulation 10 consisting of particulate build material 2 over the build area 3 in a perspective view. The accumulation 10 is shown in front of a means 9 of smoothing, viewed in the direction of movement of the means 9 of smoothing shown by arrow 4. Such a means 9 of smoothing is, for example, a blade by means of which the particulate build material 2 is smoothed, or smoothed and consolidated. FIG. 2 also shows the dimensions of width B 12, depth T 11 and height H 13 of the accumulation 10. The dimensions of depth T 11 and height H 13 may vary over the width of the blade 9 or the width B 12 of the accumulation 10, which is not shown in FIG. 2.

FIG. 3 shows an illustrative distribution of forces that act on the substrate in the case of a movement of a means 9 of smoothing, such as a blade, over a build area 3. With regard to FIG. 3, reference is made to the description relating to FIGS. 1 and 2, in which the constituents shown again in FIG. 3 have already been elucidated.

The means 9 of smoothing is moved horizontally for example in the direction of movement shown by the arrow 4 across the surface of the build area 3. An accumulation 10 is formed by the excessively discharged particulate build material 2 in front of the blade 9.

The movement of the blade 9, which may be disposed aligned at an angle other than the perpendicular, and the intrinsic weight of the discharged particulate build material 2 in the accumulation 10, give rise to forces.

Such forces generally have a horizontal component and a vertical component. The horizontal component, referred to as force FH, acts parallel to the surface of the build area 3 in a region of the last applied layer of the particulate build material 2.

The force FH is caused by the horizontal movement of the means 9 of smoothing, such as a blade.

In FIG. 3, the forces elucidated here are drawn in by way of example at a working point 14, which lies in the region of the surface of the layer of the particulate build material 2 to be created in the current step or coating operation.

The vertical component, referred to as force Fv, acts perpendicularly to the surface of the build area 3 or perpendicularly to the last applied layer of the particulate build material 2. The force Fv is caused by the weight of the particulate build material 2, especially the particulate build material 2 present in the accumulation 10. In practice, the forces FH and Fv are superposed, giving rise to a resultant force FR. This resultant force FR is directed at an angle between 0° and 90° to the surface of the build area 3 or a perpendicular which is not shown in FIG. 3, which is determined by the proportions of the forces FH and Fv and may be different at different points in the accumulation 10, especially along the width 12 of the accumulation 10. It is likewise possible for the magnitude of the resulting force FR to be different in size at different points.

In FIG. 3, the resultant force FR is shown by means of an arrow, by way of example at an angle of about 30° to the surface of the build area 3.

These resultant forces FR acting on the substrate can cause, for example, horizontal movements in one or more layers of the already applied particulate build material 2, which may also have been partly selectively consolidated. This results in inaccuracies with regard to the dimensions of the 3D structure to be created and in a deterioration in the quality of the 3D structures created.

FIG. 4 shows an assembly having a means of removing or taking away the particulate build material 2 from the accumulation 10 according to the prior art. In the example of FIG. 4, the means of removing or taking away the particulate build material 2 is a suction outlet 15 for suction of particulate build material 2 out of the accumulation 10, which is shown partly by a dash-dash line.

The suction outlet 15, viewed in the direction of movement 4 of a means 9 of smoothing, is disposed in front of the means 9 of smoothing the particulate build material 2, such as a blade 9, and above the accumulation 10. As already elucidated, the accumulation 10 forms in front of the blade 9 which is moved across the build area 3 in the direction of the arrow 4, and has a depth 11 and a height 13.

The suction outlet 15 has a connection 16. The suction outlet 15 may include a means 17 of generating a controllable reduced pressure, which is not shown in FIG. 4. Alternatively, the suction outlet 15 is connected via the connection 16 to a means 17 of generating a controllable reduced pressure. The reduced pressure generated by the means 17 of generating a controllable reduced pressure brings about removal of excess particulate build material 2 by suction from the accumulation 10 in the direction 18 of the particle movement shown by several parallel arrows.

The distance of the physical unit consisting of the suction outlet 15 and the connection 16 from the accumulation 10 or from the surface of the build area 3 may be varied, which is shown by a double-headed arrow in FIG. 4.

FIG. 5 shows a first assembly according to the invention with a suction outlet 15 for suction of excess particulate build material 2 out of the accumulation 10. As already known, the means 9 of smoothing moves in the direction of movement shown by the arrow 4 across the build area 3, forming the accumulation 10 in front of the means 9 of smoothing.

It is envisaged in this execution that the means 9 of smoothing is in two-part form and consists of an L-shaped main blade body 19 and a movable blade plate 20. It is also envisaged that the blade plate 20 is movable in the directions shown by the double-header arrows. The movement or shift of the blade plate 20 is achieved by a suitable means for the movement of the blade plate 20 in the directions shown by the double-headed arrow, although this means is not shown in FIG. 5. It is thus possible by a movement or shift of the blade plate 20 to make a change in the gap size of the gap 22 in an automated manner.

The main blade body 19 is of L-shaped form and has a blade pocket 21 formed in the interior of the two-part blade 9 in a region which is the lowest or has a smaller distance from the surface of the build area 3 than a lower edge 24 of the main blade body 19 at the site of the developing gap 22. If excess particulate build material 2 sucked in via the gap 22 cannot be transported away under gravity by the suction outlet 15 via the connection 16 and falls back in the direction of the build area 3, it is accommodated in the blade pocket 21 and does not slip back through the gap 22 into the accumulation 10.

As apparent in FIG. 5, the lowest point in the blade pocket 21 is at a distance 23 below the lower edge 24 of the main blade body 19 at the site of the developing gap 22.

The lower edge 24 of the main blade body 19, at a distance A from the surface of the build area, is disposed or executed in the blade 9 such that this lower edge 24 can be used to determine the height H 13 of the accumulation 10 since particulate build material 2 above the distance A can be sucked in through the gap 22 and transported away into a reservoir vessel 8 of a discharger 1. By virtue of this lower edge 24 extending parallel to the surface of the build area, excess particle material from the accumulation 10 is sucked in at all points along its longitudinal extent or width B 12, even in the case of different heights H 13 of the accumulation 10, when the accumulation 10 is higher than the minimum necessary height Hₘᵢₙ at least in some places. The distance A of the main blade body 19 is provided, for example, in such a way that the distance A corresponds to the minimum necessary height Hₘᵢₙ. In this way, the effect is achieved that the accumulation 10 has a uniform height H 12 along its longitudinal extent or width B 12, which also leads to a uniform distribution of the resultant forces FR acting on layers of the particulate build material 2. These uniformly acting resultant forces FR lead to an improvement in the quality of the 3D structure to be generated, which thus has smaller variances or an improved dimensional accuracy.

FIG. 6 shows a further arrangement according to the invention with a suction outlet 16 for suction of excess particulate build material 2 out of the accumulation 10. The means 9 of smoothing is moved across the build area 3 in the direction of movement shown by the arrow 4, with formation of the accumulation 10 in front of the means 9 of smoothing.

It is also envisaged in this execution that the means 9 of smoothing is in two-part form and consists of an L-shaped main blade body 19 and a movable L-shaped blade plate 20. It is also envisaged that the blade plate 20 is movable in the directions shown by the double-headed arrows. The movement or shift of the blade plate 20 is achieved by a suitable means for the movement of the blade plate 20 in the directions shown by the double-headed arrow, although this means is not shown in FIG. 6. It is thus possible by a movement or shift of the blade plate 20 to make a change in the gap size of the gap 22 in an automated manner.

In this execution, the blade plate 20 has a blade pocket 21 formed in the interior of the blade 9. If excess particulate build material 2 sucked in via the gap 22 cannot be transported away by the suction outlet 15 via the connection 16 under gravity and falls back in the direction of build area 3, it is accommodated in the blade pocket 21 and does not slip back through the gap 22 into the accumulation 10.

The execution shown in FIG. 6 has a blade tip 25 disposed in the lower region of the main blade body 19. The blade tip 25 is positioned with its lowest point or with its lower edge above the build area 3 such that, in the event of the movement of the blade 9 with its blade tip 25 across the build area 3, a new layer of the particulate build material 2 applied is formed beneath the blade tip 25 with a defined and desired layer thickness 7. The excess particulate build material 2 is conveyed via the top side of the blade tip 25 to the longitudinal opening with the adjustable gap size 22 in the direction 18 of the particle movement via the suction outlet 15 and the connection 16 to a reservoir vessel 8 (not shown) of the discharger 1.

The blade tip 25 disposed on the main blade body 19 is secured such that it can be exchanged separately if required in the event of corresponding wear.

FIG. 7 shows a means 9 of smoothing according to the invention in a perspective view. The means 9 of smoothing is shown only with the constituents essential for elucidation. The means 9 of smoothing moves horizontally in the direction of movement 4 shown by the arrow across a build area 3 (not shown). In this embodiment too, the means 9 of smoothing has a main blade body 19 and a blade plate 20, i.e. a two-part design. At the lower side of the blade plate 20, the longitudinal gap 22 is formed between the blade plate 20 and the L-shaped main blade body 19. The excess particulate build material 2 (not shown) is sucked out via this gap 22, with movement of the particles in the direction 18 of the particle movement shown by means of the arrows. For simplification of the diagram, FIG. 7 does not show the suction outlet 15 and the connection 16 via which the excess particulate build material 2 removed by suction leaves the means 9 of smoothing and arrives in the reservoir vessel 8.

In order to prevent the particulate build material 2 present in the accumulation 10 (not shown) in front of the means 9 of smoothing from leaving the edge of the build area 3 (not shown) and hence being lost, the means 9 of smoothing has one guide profile 26 at each of the two sides or ends. By means of these guide profiles 26, the accumulation 10 is bounded laterally, and the accumulation 10 is prevented from having a lower height H 13 in the edge regions since, in these edge regions, the particulate build material 2 can fall or trickle off the build area 3. In this way, moreover, the losses of particulate build material 2 when the means 9 of smoothing travels across the build area 3 are minimized.

In this execution too, the blade plate 20 may be shifted and hence the gap size of the gap 22 may be adjusted. This option is not shown in FIG. 7.

In addition, the main blade body 19 or the blade plate 20 may have a blade pocket 21.

Designs in which a blade tip 25 is disposed at the lower end of the main blade body 19 are likewise possible.

FIG. 8 shows the means according to the invention from FIG. 7 in a top view. The main blade body 19 and the blade plate 20 are apparent, which together form the means 9 of smoothing.

At the ends of the means 9 of smoothing are disposed the guide profiles 26 that laterally bound the accumulation 10 (not shown). In this way, the particulate build material 2 present in the accumulation 10 is prevented from leaving the build area 3 at the sides and hence no longer being available for the 3D printing process.

The guide profile 26 may be disposed on and mechanically connected to the blade plate 20 or the main blade body 19. The guide profile 26 has, for example, a triangular lateral boundary by which the guide profile 26 protrudes from the blade plate 20, and which forms a lateral boundary for the accumulation 10 that forms in operation of the 3D printer. The guide profile 26 may also have a triangular base plate aligned parallel to the surface of the build area 3, which forms a gradual transition between the guide profile 26 and the means 9 of smoothing, especially the main blade body 19.

FIG. 9 shows the recycling of the excess particulate build material 2 from an accumulation 10 into the reservoir vessel 8, using the example of the prior art. FIG. 9 is not to scale and also does not show any real separations of the assemblies from one another, but serves merely for illustration of the principle of recycling the excess particulate build material 2 into the reservoir vessel 8.

FIG. 9 shows a discharger 1 disposed above the build area 3, which is already known from FIG. 1 and hence need not be described any further. Shown in the right-hand portion of FIG. 9, by way of example, is the arrangement known from FIG. 4 with a suction outlet 15 for suction of particulate build material 2 out of the accumulation 10.

The excess particulate build material 2 removed or sucked out of the accumulation 10 that forms in front of the means 9 of smoothing passes via the suction outlet 15, the connection 16 and a conduit 27 to the reservoir vessel 8 of the applicator 1. Thus, the excess particulate build material 2 is directly fed or returned to the operation of applying the particulate build material 2 by means of the applicator 1.

In FIG. 9, by way of example, a means 17 of generating the reduced pressure is disposed in the conduit 27. Such a means 17 may alternatively also be disposed in the suction outlet 15. As a further alternative, such a means 17 may also be disposed in more than one place, for example at both ends of the conduit 27. What is essential is that such a means 17 generates a controllable reduced pressure such that the excess particulate build material 2 is removed from the accumulation 10 and transported into the reservoir vessel 8 of the discharger 1, as shown in the example of FIG. 9. The means 9 of smoothing shown in FIG. 9 may be exchanged for the means 9 of smoothing according to the invention shown in FIG. 5, with maintenance of the functionality of recycling the excess particulate build material 2 from the accumulation 10 into the reservoir vessel 8.

### LIST OF REFERENCE NUMERALS

1 discharger
2 particulate build material
3 build area
4 arrow/direction of movement
5 outlet
6 discharge
7 layer thickness
8 reservoir vessel
9 means of smoothing/blade
10 accumulation
11 depth T
12 width B
13 height H
14 working point
15 suction outlet
16 connection
17 means of generating a controllable reduced pressure
18 direction of the particle movement
19 main blade body
20 blade plate
21 blade pocket
22 gap size/gap
23 distance
24 lower edge
25 blade tip
26 guide profile
27 conduit

1. An assembly for application of particulate build material in a 3D printer having a means of smoothing the particulate build material discharged by a discharger onto a build area, wherein the means of smoothing has a gap on an inlet side that extends in a longitudinal extent of the means of smoothing, by means of which excess particulate build material is sucked away from an accumulation present in front of the means of smoothing in a direction of movement, wherein the means of smoothing has a suction outlet disposed on an outlet side, wherein the means of smoothing has an L-shaped main blade body and a movable blade plate between which a cavity is formed, which is connected on the inlet side to the gap and on the outlet side to the suction outlet, wherein the movable blade plate is in a movable arrangement relative to the L-shaped main blade body, where a movement of the movable blade plate relative to the L-shaped main blade body changes a gap size of the gap and hence a distance between the L-shaped main blade body and the movable blade plate, and wherein a blade pocket is disposed in at least one of the L-shaped main blade body or, if the movable blade plate is L-shaped, the L-shaped movable blade plate.

2. The assembly as claimed in claim 1, wherein the suction outlet is connected via a connector to a reservoir vessel of the discharger for recycling of the excess particulate build material from the accumulation into the reservoir vessel, wherein a means of generating a reduced pressure is disposed at least one of in the means of smoothing, on the means of smoothing, or on or in a conduit connected to the means of smoothing.

3. The assembly as claimed in claim 1, wherein a blade tip is disposed on the L-shaped main blade body and/or wherein at least one guide profile is disposed on at least one of the L-shaped main blade body or the movable blade plate.

4. A method of applying particulate build material in a 3D printer, comprising:
applying the particulate build material layer by layer in a build area of the 3D printer; and
smoothing the particulate build material that has been discharged by a discharger onto a surface of the build area and accumulates in an accumulation in front of a means of smoothing, wherein a height of the accumulation is controlled wherein particulate build material is partly removed from the accumulation, wherein the particulate build material partly removed from the accumulation is returned to a reservoir vessel of the discharger, and wherein the excess particulate build material is sucked out of the accumulation via a gap having a variable gap size and disposed in the means of smoothing, and is returned to the reservoir vessel of the discharger, wherein the means of smoothing is provided with an L-shaped main blade body and a movable blade plate between which the gap is formed.

5. The method as claimed in claim 4, wherein solely excess particulate build material which is not required to form a minimum necessary height of the accumulation is returned to the reservoir vessel of the discharger.

6. The method as claimed in claim 5, wherein the minimum necessary height of the accumulation is that height of the accumulation which is required to be able to apply a layer of the particulate build material uniformly, with a fixed layer thickness and without defects on the surface of the build area.

7. The method as claimed in claim 4, wherein the excess particulate build material is sucked out of the accumulation via the gap disposed in the means of smoothing out of a region in front of the means of smoothing, viewed in a direction of movement of the means of smoothing, and returned to the reservoir vessel of the discharger.

8. The method as claimed in claim 4, wherein an amount of the excess particulate build material removed by suction is controlled as a function of at least one of the amount of the particulate build material discharged by the discharger or as a function of the height of the accumulation or as a function of the layer or layers beneath the layer created in during smoothing.

9. (canceled)

10. A device for smoothing particulate build material discharged by a discharger onto a build area in a 3D printer, the device comprising:
a gap on an inlet side that extends a longitudinal extent of the device, the gap removing excess particulate build material from an accumulation of the particulate build material present in front of the device in a direction of movement,
a suction outlet disposed on an outlet side,
an L-shaped main blade body and a movable blade plate between which a cavity is formed, the cavity connected on the inlet side to the gap and on the outlet side to the suction outlet,
wherein:
the movable blade plate is movable relative to the L-shaped main blade body;
movement of the movable blade plate relative to the L-shaped main blade body changes a gap size of the gap; and
a blade pocket is disposed in at least one of the L-shaped main blade body or, if the movable blade plate is L-shaped, the L-shaped movable blade plate.
